(19) United States
(12) Patent Application Publication
(10) Pub. No.: US 2017/0010163 A1
(43) Pub. Date: Jan. 12, 2017

(54) HIGH FREQUENCY INDUCTION HEATING METHOD

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 15/197,005

(22) Filed: Jun. 29, 2016

(30) Foreign Application Priority Data
Jul. 7, 2015 (JP) 2015-136000

(51) Int. Cl. G01K 11/06; B22F 3/24; H01F 1/057; H05B 6/10

(52) U.S. Cl. CPC G01K 11/06; H05B 6/10; B22F 3/24; H01F 1/0577; H01F 1/0576; B22F 2003/248

(57) ABSTRACT

A high frequency induction heating method includes: providing a film containing a component, which melts at a preset heating temperature, on a surface of a workpiece before heating the workpiece by high frequency induction heating using a high-frequency coil; and heating the workpiece by high frequency induction heating.

### INCORPORATION BY REFERENCE

The disclosure of Japanese Patent Application No. 2015-136000 filed on Jul. 7, 2015 including the specification, drawings and abstract is incorporated herein by reference in its entirety.

### BACKGROUND OF THE INVENTION

1. Field of the Invention

The present invention relates to a method of heating a workpiece by high frequency induction heating using a high-frequency coil.

2. Description of Related Art

Rare earth magnets made from rare earth elements such as lanthanoids are called permanent magnets and are used for drive motors of hybrid vehicles, electric vehicles, and the like as well as motors included in hard disks and MRIs.

As an index indicating magnet performance of these rare earth magnets, for example, residual magnetization (residual magnetic flux density) and coercive force may be used. Along with a decrease in the size of a motor and an increase in current density, the amount of heat generation increases, and thus the demand for high heat resistance has further increased in rare earth magnets which are used. Accordingly, one of the important research issues in this technical field is how to maintain magnetic characteristics of a magnet when used at a high temperature.

Examples of rare earth magnets include commonly-used sintered magnets in which a grain size of crystal grains (main phase) constituting a structure thereof is about 3 μm to 5 μm; and nanocrystalline magnets in which crystal grains are refined to a nano grain size of about 50 nm to 300 nm.

An example of a method of manufacturing a rare earth magnet will be briefly described. For example, Nd—Fe—B molten metal is rapidly solidified to obtain a fine powder (magnet powder), and the magnet powder is press-formed in a forming die to obtain a compact. Next, the compact is compressed and densified in a high-temperature atmosphere to obtain a sintered compact, and hot working is performed on this sintered compact so as to impart magnetic anisotropy thereto. As a result, a rare earth magnet (oriented magnet) is manufactured.

Regarding the above-described hot working, a heating device which includes a high-frequency coil and a forming die for forging the heated sintered compact are prepared. A current is applied to a high-frequency coil to generate a high frequency induction current, and due to this high frequency induction current, the sintered compact in the heating device is heated by high frequency induction heating at about 600° C. to 900° C. Next, the heated sintered compact is transferred to the forming die so as to be forged. As a result, the sintered compact is plastically deformed, and a rare earth magnet is manufactured.

It is known that, in the rare earth magnet manufactured as described above, the heating temperature of the sintered compact during the hot working has a large effect on magnetic characteristics of a finally obtained rare earth magnet. Therefore, in order to obtain a rare earth magnet having satisfactory magnetic characteristics, it is important to control the temperature of a sintered compact during hot working to be in a range of a preset temperature (target temperature)±5° C.

### SUMMARY OF THE INVENTION

The present inventors investigated a configuration in which the surface temperature of a sintered compact during heating is measured using a thermocouple of a radiation thermometer after coating a surface of the sintered compact with a lubricant (graphite).

As a result of the measurement, it was found that, in a case where sintered compacts, which should have the same heating temperature under normal conditions, are measured using a radiation thermometer, the measurement results vary depending on the rare earth magnets by about 20° C. It was also found that, even in the same sintered compact, the surface temperature is higher than the internal temperature of the sintered compact.

Accordingly, the present inventors have made, for example, the following attempts: (1) an attempt to realize more accurate temperature measurement; (2) an attempt to specify processing conditions (for example, a material composition or a strain rate) under which, even in a case where the temperature varies depending on sintered compacts, the same characteristics can be obtained; and (3) an attempt to control the heating of a sintered compact such that the sintered compact can be heated at the same temperature simply by setting the output or the time of a high frequency heating device without measuring the temperature of the sintered compact.

Regarding the attempt (3) among the attempts (1) to (3), for example, even in a case where the amount of heat required to heat a sintered compact to a preset temperature (target temperature) changes due to a change in the temperature of the sintered compact before heating, the same amount of heat is introduced into the sintered compact, which causes an excessive temperature increase. In a case where the output setting of a heating device (the output setting of an IGBT) is not changed, the amount of heat introduced into a sintered compact may change due to a temperature change of a heating coil, the position of the sintered compact in the heating coil, or the like.

Accordingly, a measure for controlling the temperature of a sintered compact, which is a rare earth magnet precursor, to be a preset heating temperature even in a case where the amount of heat required or the amount of heat introduced changes is desired in this technical field.

Here, Japanese Patent Application Publication No. 2000-228278 (JP 2000-228278 A) discloses a high frequency induction heating device. Specifically, in this device, a high frequency induction current is generated by applying a current to a high frequency induction heating coil arranged around a heating target, and when the heating target is heated by this high frequency induction current, the surface temperature of the heating target is measured at two positions or three or more positions using a radiation thermometer, and the high frequency induction heating coil is moved relative to the heating target in a direction in which a difference between the measured values at the measurement positions decreases.

According to this device, the heating target can be uniformly heated or joined by the high frequency induction current. However, the main object of the device is to accurately measure the temperature of the heating target, and unlike the above-described attempt, a workpiece such as a sintered compact cannot be heated to a preset temperature during high frequency induction heating without measuring the temperature of the workpiece.

The invention provides a high frequency induction heating method in which a workpiece such as a sintered compact can be heated to a preset temperature during high frequency induction heating without measuring the temperature of the workpiece.

According to an aspect of the invention, there is provided a high frequency induction heating method including: providing a film containing a component, which melts at a preset heating temperature, on a surface of a workpiece before heating the workpiece by high frequency induction heating using a high-frequency coil; and heating the workpiece by high frequency induction heating.

In the high frequency induction heating method according to the aspect of the invention, a film containing a component, which melts at a preset heating temperature, is provided on a surface of a workpiece before heating the workpiece by high frequency induction heating. Here, “the preset heating temperature” refers to a preset heating temperature for the surface of the workpiece. In a case where it is desired to heat the surface of the workpiece to 800° C., the preset heating temperature is 800° C.

The workpiece to be heated by high frequency induction heating is not particularly limited, and as described above, examples thereof include a sintered compact which is a rare earth magnet precursor. Accordingly, in a case where the workpiece is a sintered compact which is a rare earth magnet precursor, the high frequency induction heating may be performed before performing hot working on the sintered compact.

As described above, when the workpiece is heated by high frequency induction heating, the surface temperature becomes higher than the internal temperature of the workpiece. Accordingly, in general, a problem of an excessive temperature increase occurs on the surface of the workpiece. Therefore, when an excessive increase in surface temperature of the workpiece is suppressed, a problem of an excessive increase in the internal temperature of the workpiece does not occur.

Therefore, by providing a film containing a component, which melts at a preset temperature of a surface of a workpiece (heating temperature), on the surface of the workpiece before heating the workpiece by high frequency induction heating, once the surface temperature reaches the preset heating temperature, the component in the film melts, heat is absorbed due to latent heat of melting, and an excessive increase in the surface temperature of the workpiece can be suppressed.

For example, on the surface of the workpiece, a temperature distribution is likely to be generated depending on the position of the workpiece in the high-frequency coil, and a region having a higher temperature than in the other portions of the workpiece may be generated. However, even in this case, once the temperature of the high-temperature region reaches the preset heating temperature, a temperature increase is suppressed for a predetermined amount of time by the melting of the component in the film. As a result, the entire region on the surface of the workpiece can be uniformly heated, and the surface temperature in the entire region can be controlled to be the preset heating temperature.

For example, in a case where the workpiece is heated by high frequency induction heating using a heating device, which includes a high-frequency coil, and then is transferred to a forming die to be forged, even when the time required to transport the workpiece from the heating device to the forming die or the time required to transfer the workpiece to the forming die varies depending on the workpieces, or even when the heating time in the heating device varies depending on the workpieces, the workpiece can be handled while maintaining the workpiece at a constant temperature due to the film. That is, a variation in the heating temperature of the surface of the workpiece can be suppressed.

The component contained in the film is selected according to the preset heating temperature. In a case where the heating temperature is 400° C., potassium nitrate having a melting point of 400° C. is selected as the component contained in the film. In a case where the heating temperature is 800° C., sodium chloride having a melting point of 800° C. is selected as the component contained in the film.

The film can be formed using an appropriate lubricant (liquid). For example, the film can be formed by applying a solution, which is obtained by adding the sodium chloride component to a graphite lubricating liquid, to the surface of the workpiece and drying the solution.

The film may be formed of a graphite lubricating liquid and a melting component which is contained in the film.

The film may be formed by applying a solution, which is obtained by adding the melting component to the graphite lubricating liquid, to the surface of the workpiece and drying the solution.

The workpiece may have a Nd—Fe—B-based main phase with a nanocrystalline structure and a grain boundary phase of a Nd—X alloy, where X: metal element, the grain boundary phase may be present around the main phase.

The Nd—X alloy constituting the grain boundary phase may be any one of Nd—Co, Nd—Fe, Nd—Ga, Nd—Co—Fe, and Nd—Co—Fe—Ga, or is a mixture of at least two of Nd—Co, Nd—Fe, Nd—Ga, Nd—Co—Fe, and Nd—Co—Fe—Ga; and the Nd—X alloy may be in a Nd rich state.

As can be seen from the above description, the high frequency induction heating method according to the invention includes: providing a film containing a component, which melts at a preset heating temperature, on a surface of a workpiece before heating the workpiece by high frequency induction heating using a high-frequency coil; and heating the workpiece by high frequency induction heating. As a result, during the high frequency induction heating, the entire region on the surface of the workpiece can be heated to the preset temperature.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a state where a film is provided on a surface of a sintered compact which is a workpiece;

FIG. 2 is a diagram showing a state where a sintered compact is about to be inserted into a high-frequency coil;

FIG. 3 is a diagram showing a state where the heated sintered compact is about to be transferred to a forming die;

FIG. 4A is a diagram showing the results of Comparative Example in an experiment for verifying an effect of a film containing a component, which melts at a preset heating temperature, suppressing an excessive increase in the temperature of a workpiece; and

FIG. 4B is a diagram showing the results of Example in the experiment for verifying an effect of a film containing a component, which melts at a preset heating temperature, suppressing an excessive increase in the temperature of a workpiece.

### DETAILED DESCRIPTION OF EMBODIMENTS

Hereinafter, an embodiment of a high frequency induction heating method according to the invention will be described with reference to the drawings. A workpiece in an example shown in the drawing is a sintered compact which is a rare earth magnet precursor. However, of course, the workpiece is not limited to a sintered compact.

(Embodiment of High Frequency Induction Heating Method)

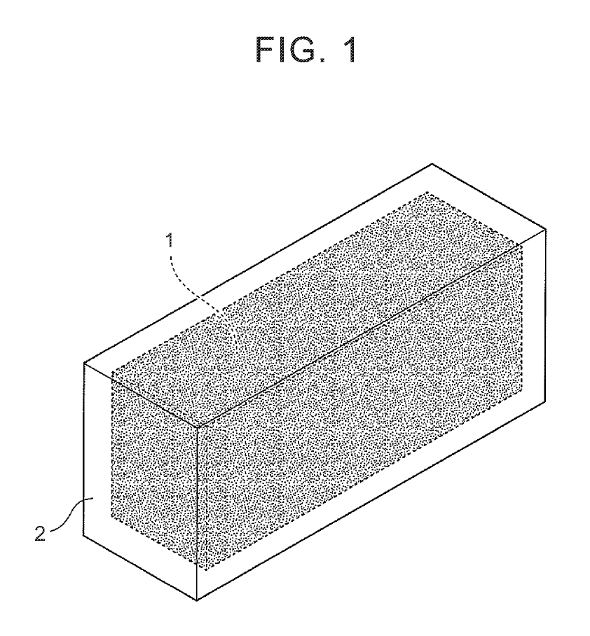

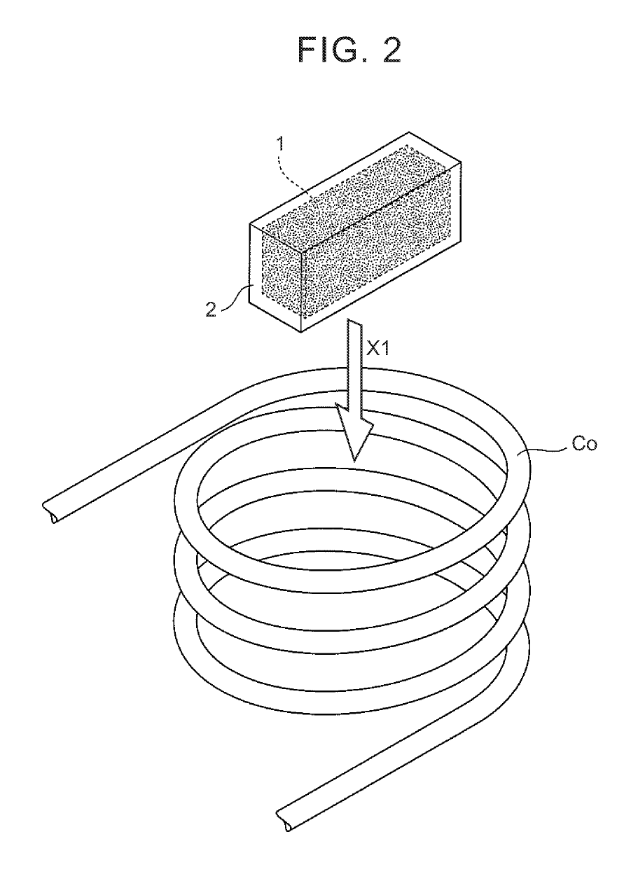

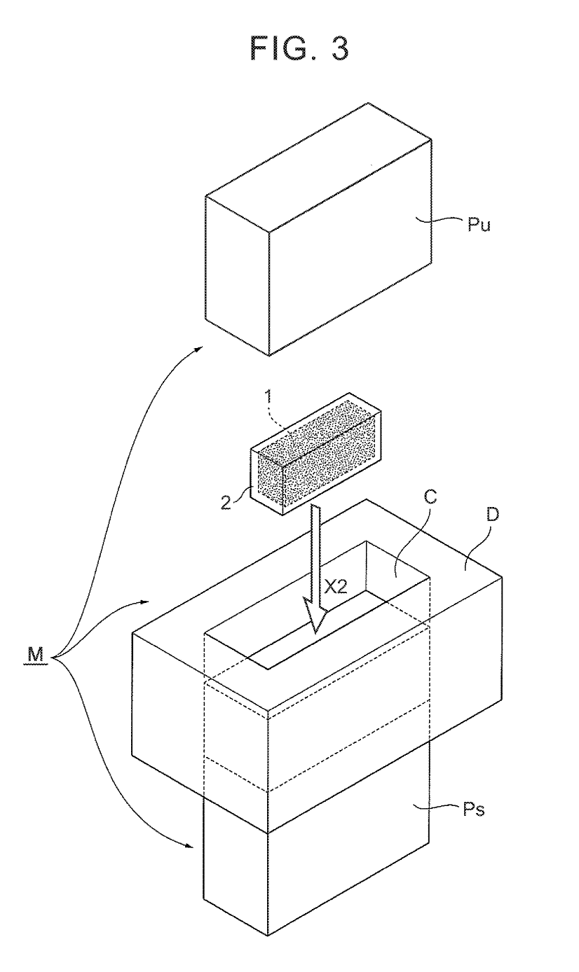

FIG. 1 is a diagram showing a state where a film is provided on a surface of a sintered compact which is a workpiece, and FIG. 2 is a state where a sintered compact is about to be inserted into a high-frequency coil. FIG. 3 is a diagram showing a state where a heated sintered compact is transferred to a forming die.

First, as shown in FIG. 1, a film 2 is formed on a surface of a sintered compact 1 (workpiece) which is a rare earth magnet precursor.

Here, the sintered compact 1 is manufactured by press-forming magnet powder in a forming die (not shown) in a high-temperature atmosphere of about 700° C. In a method of preparing the magnet powder, in a furnace (not shown) in which the pressure is reduced to 50 kPa or lower, an alloy ingot is melted by high-frequency induction heating using a single-roll melt spinning method, and molten metal having a composition of a rare earth magnet is injected to a copper roll to prepare a rapidly-quenched ribbon. Next, this rapidly-quenched ribbon is crushed to prepare a magnet powder. The grain size range of the magnet powder is adjusted to be in a range of 75 μm to 300 μm.

The sintered compact 1 has: a Nd—Fe—B-based main phase with a nanocrystalline structure (having an average grain size of about 300 nm or less, for example, a grain size of about 50 nm to 200 nm); and a grain boundary phase of a Nd—X alloy (X: metal element) present around the main phase. The Nd—X alloy constituting the grain boundary phase is an alloy of Nd and at least one of Co, Fe, Ga, and the like and is in a Nd-rich state. For example, any one of Nd—Co, Nd—Fe, Nd—Ga, Nd—Co—Fe, and Nd—Co—Fe—Ga, or a mixture of at least two of Nd—Co, Nd—Fe, Nd—Ga, Nd—Co—Fe, and Nd—Co—Fe—Ga may be used.

The film 2 formed on the surface of the sintered compact 1 is formed of a graphite lubricating liquid and a melting component which is contained in the film 2.

This melting component refers to a component which melts at a preset heating temperature for the surface of the sintered compact 1 when the sintered compact 1 is heated by high frequency induction heating using a high-frequency coil Co shown in FIG. 2, that is, before the high frequency induction heating.

For example, when a rare earth magnet is manufactured by performing hot working on the sintered compact 1, the heating temperature before the hot working is set to be about 600° C. to 900° C. Accordingly, in a case where the preset temperature for the surface of the sintered compact 1 is 670° C., iron (II) chloride tetrahydrate (FeCl₂4H₂O) having a melting point of 670° C. may be used as the melting component. In a case where the preset temperature is 770° C., potassium chloride (KCl) having a melting point of 770° C. may be used as the melting component.

As shown in FIG. 2, the sintered compact 1 having a surface on which the film 2 is provided is put into the high-frequency coil Co (X1 direction) and is heated by high frequency induction heating for a predetermined amount of time.

During this high frequency induction heating, on the surface of the sintered compact 1, a temperature distribution is likely to be generated depending on the position of the sintered compact 1 in the high-frequency coil Co, and a region having a higher temperature than in the other portions of the sintered compact 1 may be generated. Even in this case, once the temperature of the high-temperature region reaches a preset heating temperature, a temperature increase is suppressed for a predetermined amount of time by the melting of the component in the film 2 (melting component). As a result, the entire region on the surface of the sintered compact 1 can be uniformly heated, the surface temperature in the entire region can be controlled to be a preset heating temperature, and an excessive increase in the temperature of the entire or a partial region of the sintered compact 1 is suppressed.

Once the entire region of the sintered compact 1 is uniformly heated to a preset temperature by a predetermined amount of time of high frequency induction heating, the heated sintered compact 1 is transferred to a cavity C of the forming die M.

The forming die M includes: a die D; and an upper punch Pu and a lower punch Ps that slide on the inside of the die D. The cavity C is formed by the die D, the upper punch Pu, and the lower punch Ps.

The heated sintered compact 1 is put into the cavity C (X2 direction), and the sintered compact 1 is forged by being compressed by the upper punch Pu and the lower punch Ps. As a result, magnetic anisotropy is imparted to the sintered compact 1, and a rare earth magnet (not shown) is manufactured.

The entire region of the sintered compact 1 before the hot working is uniformly heated to a preset heating temperature by the high frequency induction heating method shown in the drawing, and an excessively heated portion is not present. Therefore, a rare earth magnet having satisfactory magnetic characteristics such as residual magnetization or coercive force is manufactured.

(Experiment for Verifying Effect of Film Containing Component, which Melts at Preset Heating Temperature, Suppressing Excessive Increase in Temperature of Workpiece, and Results Thereof)

The present inventors performed an experiment for verifying an effect of a film containing a component, which melts at a preset heating temperature, suppressing an excessive increase in the temperature of a workpiece.

First, a sintered compact was used as the workpiece, and a preset heating temperature of a surface of the sintered compact was set as 800° C. Next, NaCl (1.0 g; melting point: 800° C.) was mixed with 0.1 g of a graphite lubricating liquid (PROHYTE 15FU, manufactured by Nippon Graphite Industries, Ltd.), and this mixture was applied to a surface of the sintered compact and was sufficiently dried. As a result, a film having a thickness of 50 μm to 100 μm was formed. Heat absorption of 483 kJ can be expected from 1 g of melted NaCl.

The sintered compact having a surface on which the film was formed was heated using a high frequency induction heating device. At this time, a thermocouple was provided by welding on the surface of the sintered compact to measure the temperature (hereinabove, Example).

Here, the specific heat of the sintered compact was 410 J/kg·K, the size of the sintered compact was 7.2 mm×28.2 mm×18.9 mm, the density of the sintered compact was 7.6 g/cm³, the amount of heat required to increase the temperature of the sintered compact by 1° C. was 11.96 J, and when all of 1 g of NaCl melts, an effect of suppressing an excessive temperature increase at 40.38° C. (483 J/11.96 (J/K)) can be expected.

On the other hand, as Comparative Example, a sintered compact having a surface on which a film consisting of only a graphite lubricating liquid without adding NaCl was formed was prepared. At this time, as in the case of Example, a thermocouple was provided by welding on the surface of the sintered compact to measure the temperature.

TYPE 3 (manufactured by Yutaka Electronics Industry Co., Ltd.) was used as a heating device, and heating conditions were 10 kHz, 50 A, and 75 seconds.

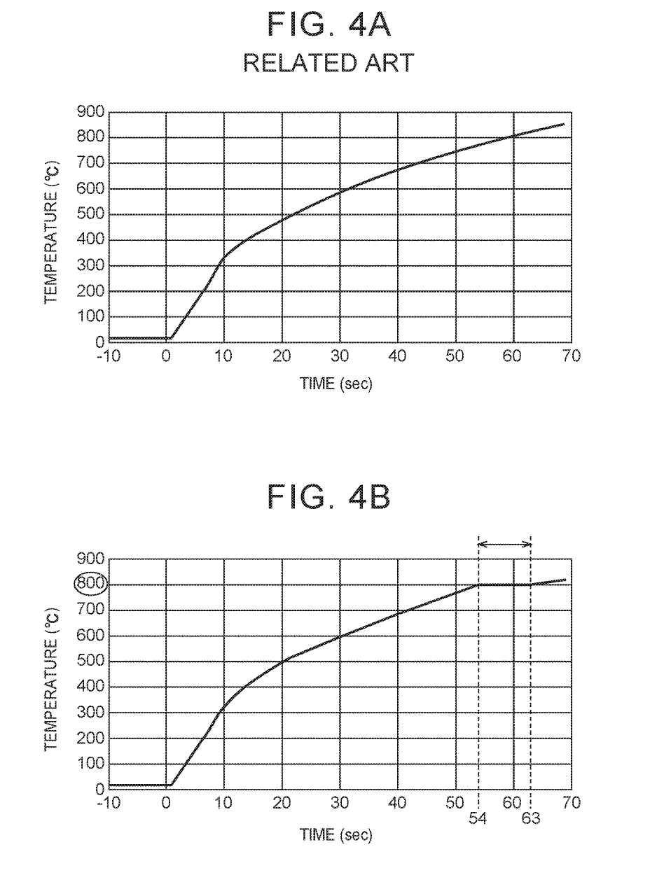

Regarding the measurement results, FIG. 4A shows the measurement results of Comparative Example, and FIG. 4B shows the measurement results of Example.

It was found from FIG. 4A that, in the sintered compact of Comparative Example, the surface temperature increased over time and was excessively increased to exceed 800° C. which was a preset heating temperature.

On the other hand, it was found from FIG. 4B that, in the sintered compact of Example, the surface temperature increased over time; however, a temperature increase was stopped at 800° C. which was the melting point of NaCl, the temperature was stable at 800° C. for about nine seconds, and thus an excessive temperature increase was suppressed. This result was derived from an endothermic reaction of NaCl, and the effect of the film containing a component, which was melted at a preset heating temperature, was able to be verified. That is, as shown in FIG. 4B, it was found that, in a time period from 54 seconds to 63 seconds, heat was absorbed by the melting of NaCl, and the temperature was stable. The period of time in which a temperature increase can be suppressed depends on the high frequency output (temperature increase rate).

Next, Table 1 below shows the list of components to be contained in a film and melting point thereof.

TABLE 1

| | | Melting |
|---|---|---|
| Compound Name | Formula | Point (° C.) |
| Tin (II) Chloride | SnCl₂ | 246 |
| Sodium Nitrite | NaNO₂ | 271 |
| Zinc Chloride | ZnCl₂ | 293 |
| Zirconium (III) Chloride | ZrCl₃ | 330 |
| Potassium Nitrite | KNO₂ | 350 |
| Potassium Nitrate | KNO₃ | 400 |
| Ammonium Chloride | NH₄Cl | 520 |
| Iron (II) Chloride Tetrahydrate | FeCl₂4H₂O | 670 |
| Potassium Chloride | KCl | 770 |
| Calcium Chloride | CaCl₂ | 782 |
| Sodium Carbonate | Na₂CO₃ | 851 |

A component to be contained in a film can be appropriately selected from the list of Table 1 according to the preset heating temperature for the surface of the workpiece. By selecting two or more components from the list of Table 1 and forming a film containing the components, the temperature can be controlled in various ways.

Hereinabove, the embodiments of the present invention have been described with reference to the drawings. However, a specific configuration is not limited to the embodiments, and design changes and the like which are made within a range not departing from the scope of the invention are included in the present invention.

What is claimed is:

1. A high frequency induction heating method comprising:
providing a film containing a component, which melts at a preset heating temperature, on a surface of a workpiece before heating the workpiece by high frequency induction heating using a high-frequency coil; and
heating the workpiece by high frequency induction heating.

2. The high frequency induction heating method according to claim 1, wherein
the workpiece is a sintered compact which is a rare earth magnet precursor, and
the sintered compact is heated by high frequency induction heating while performing hot working on the sintered compact.

3. The high frequency induction heating method according to claim 1, wherein
the film is formed of a graphite lubricating liquid and a melting component which is contained in the film.

4. The high frequency induction heating method according to claim 3, wherein
the film is formed by applying a solution, which is obtained by adding the melting component to the graphite lubricating liquid, to the surface of the workpiece and drying the solution.

5. The high frequency induction heating method according to claim 1, wherein
the workpiece has a Nd—Fe—B-based main phase with a nanocrystalline structure and a grain boundary phase of a Nd—X alloy, where X: metal element, the grain boundary phase being present around the main phase.

6. The high frequency induction heating method according to claim 5, wherein
the Nd—X alloy constituting the grain boundary phase is any one of Nd—Co, Nd—Fe, Nd—Ga, Nd—Co—Fe, and Nd—Co—Fe—Ga, or is a mixture of at least two of Nd—Co, Nd—Fe, Nd—Ga, Nd—Co—Fe, and Nd—Co—Fe—Ga; and
the Nd—X alloy is in a Nd rich state.
